(19) United States
(12) Patent Application Publication
(10) Pub. No.: US 2026/0356391 A1
(43) Pub. Date: Nov. 12, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Su Young CHOI, Hwaseong-si (KR); Su Jin HAN, Hwaseong-si (KR)

(21) Appl. No.: 19/632,770

(22) Filed: Mar. 30, 2026

(30) Foreign Application Priority Data
May 7, 2025 (KR) 10-2025-0059105

(51) Int. Cl. B60W 60/00; B60W 50/14

(52) U.S. Cl. CPC B60W 60/0013; B60W 50/14; B60W 2050/146; B60W 2552/53

(57) ABSTRACT

A control device for an autonomous vehicle and a method for controlling the same are disclosed. A control device for an autonomous vehicle may comprise: a memory configured to store at least one instruction; and one or more processors connected to the memory, wherein, when the instructions are executed by the one or more processors, the control device may be configured to: set one or more route points on an existing route including lane information, calculate a first correction value for smoothing a curvature of the route points, calculate a second correction value for moving the route points to a lane center, selectively correct the route points based on the first correction value and the second correction value, and generate a driving route including one or more corrected route points.

### CROSS-REFERENCE TO RELATED APPLICATION

This application claims the benefit of priority to Korean Patent Application No. 10-2025-0059105, filed in the Korean Intellectual Property Office on May 7, 2025, the disclosure of which is incorporated herein by reference in its entirety.

### TECHNICAL FIELD

Various examples of the present disclosure relate to an autonomous vehicle and a method of controlling the autonomous vehicle.

### BACKGROUND

The matters described in this Background section are only for enhancement of understanding of the background of the disclosure, and should not be taken as acknowledgment that they correspond to prior art already known to those skilled in the art.

Autonomous vehicles may set driving routes based on precise maps and move along a lane center.

However, on roads with high curvature, such as curved sections of highways and sharp curves in urban areas, following the route on a precise map may result in unnecessary sharp steering, which may cause a problem that ride comfort perceived by a passenger may deteriorate.

### SUMMARY

The present disclosure is directed to generating a more flexible autonomous driving route by applying an optimization algorithm that considers curvature smoothing and lane keeping.

According to the present disclosure, an apparatus of a vehicle may comprise a processor and a memory storing at least one instruction that, when executed by the processor, is configured to cause the apparatus to set, based on lane boundary information of a driving lane of the vehicle, a plurality of route points on an existing driving route of the vehicle, determine a first adjustment value for reducing amounts of curvature changes of the plurality of route points, determine a second adjustment value for moving the plurality of route points toward a lane center of the driving lane of the vehicle, adjust, based on the first adjustment value and the second adjustment value, the plurality of route points, generate an updated driving route comprising the adjusted plurality of route points, output a signal indicating the updated driving route, and control, based on the signal, an operation of the vehicle.

The at least one instruction, when executed by the processor, may be configured to cause the apparatus to output the updated driving route through an interface of the vehicle and control autonomous driving of the vehicle along the updated driving route. The plurality of route points may be set to be spaced a predetermined distance apart from each other on the existing driving route. The at least one instruction, when executed by the processor, may be configured to cause the apparatus to determine the first adjustment value based on amounts of curvature changes at a plurality of reference positions, wherein the plurality of reference positions comprise positions located to a left side of the driving lane and positions located to a right side of the driving lane.

The at least one instruction, when executed by the processor, may be configured to cause the apparatus to determine the second adjustment value based on a center position between a left lane boundary of the driving lane and a right lane boundary of the driving lane. The at least one instruction, when executed by the processor, may be configured to cause the apparatus to determine the second adjustment value to minimize a distance difference between each of the plurality of route points and the center position. The at least one instruction, when executed by the processor, may be configured to cause the apparatus to adjust the plurality of route points based on the first adjustment value and the second adjustment value indicating a same direction of movement. The at least one instruction, when executed by the processor, may be configured to cause the apparatus to adjust a position of a route point of the plurality of route points based on the first adjustment value and the second adjustment value indicating a same direction of movement and a sum of the first adjustment value and the second adjustment value.

The at least one instruction, when executed by the processor, may be configured to cause the apparatus to iteratively adjust the plurality of route points until an amount of change in the iterative adjustment satisfies a threshold condition. The at least one instruction, when executed by the processor, may be configured to cause the apparatus to determine that the updated driving route is a final route based on an amount of change in an adjustment value between successive adjustments less than a preset reference value.

According to the present disclosure, a method performed by an apparatus of a vehicle may comprise setting, based on lane boundary information of a driving lane of the vehicle, a plurality of route points on an existing driving route of the vehicle, determining a first adjustment value for reducing amounts of curvature changes of the plurality of route points, determining a second adjustment value for moving the plurality of route points toward a lane center of the driving lane of the vehicle, adjusting, based on the first adjustment value and the second adjustment value, the plurality of route points, generating an updated driving route comprising the adjusted plurality of route points, outputting a signal indicating the updated driving route, and controlling, based on the signal, an operation of the vehicle.

According to the present disclosure, a vehicle may comprise a sensor configured to obtain lane boundary information of a driving lane of the vehicle and a processor circuit configured to cause the vehicle to set, based on the lane boundary information, a plurality of route points on an existing driving route of the vehicle, determine, for each route point of the plurality of route points, a first adjustment value based on curvature changes at reference positions on a left side of the driving lane and a right side of the driving lane, determine, for each route point of the plurality of route points, a second adjustment value based on a center position between a left lane boundary of the driving lane and a right lane boundary of the driving lane, based on the first adjustment value and the second adjustment value indicating a same direction of movement, adjust a position of at least one route point of the plurality of route points, generate an updated driving route, wherein the updated driving route comprises the adjusted positions of the plurality of route points, output a signal indicating the updated driving route, and control, based on the signal, autonomous driving of the vehicle.

The processor circuit may be configured to cause the vehicle to set the plurality of route points to be spaced a predetermined distance apart from each other on the existing driving route. The processor circuit may be configured to cause the vehicle to iteratively adjust the plurality of route points until an amount of change in the iterative adjustment satisfies a threshold condition.

Objects of the present disclosure are not limited to the above objects, and other objects that are not described will be able to be clearly understood by those skilled in the art based on the following description.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of an autonomous vehicle;

FIG. 2 shows an example of generation of a curved section autonomous driving route;

FIG. 3 shows an example of generating of the curved section autonomous driving route in detail; and

FIG. 4, FIG. 5, FIG. 6, and FIG. 7 show examples of generation of the curved section autonomous driving route.

FIG. 8 shows an example computing system.

### DETAILED DESCRIPTION

Hereinafter, exemplary examples of the present disclosure will be described in detail with reference to the accompanying drawings.

However, the technical idea of the present disclosure is not limited to some examples to be described, but may be implemented in various different forms, and within the scope of the technical idea of the present disclosure, one or more constituent elements among the examples may be selectively combined or substituted for use.

In addition, terms used in the examples of the present disclosure (including technical and scientific terms) may be interpreted as having a meaning that may be generally understood by a person of ordinary skill in the art to which the present disclosure pertains, unless explicitly defined and described otherwise, and commonly used terms such as those defined in advance will be interpreted in consideration of the contextual meaning of the related art.

Furthermore, the terms used in the examples of the present disclosure are for describing the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all combinations of the listed items. For example, “at least one of A or B” may refer to (1) at least one A; (2) at least one B; or (3) at least one A and at least one B.

In addition, in describing the constituent elements of the examples of the present disclosure, terms such as first, second, A, B, (a), (b), etc., may be used. These terms are only for distinguishing the constituent element from other constituent elements, and the essence, order, or sequence of the corresponding constituent element is not limited by the terms.

And, when a constituent element is described as being ‘connected’, ‘coupled’, or ‘joined’ to another constituent element, it may include not only cases where the constituent element is directly connected, coupled, or joined to the other constituent element, but also cases where it is ‘connected’, ‘coupled’, or ‘joined’ through another constituent element between the constituent element and the other constituent element.

In addition, when described as being formed or placed “on (top of) or under (below)” each constituent element, on (top of) or under (below) includes not only cases where the two constituent elements are in direct contact with each other, but also cases where one or more other constituent elements are formed or placed between the two constituent elements. In addition, when expressed as “on (top of) or under (below),” it may include the meaning of not only the upward direction but also the downward direction with respect to one constituent element.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous-driving settings (e.g., an autonomous-driving classification or a selected autonomous-driving level for the vehicle). When the feature of enhanced driving-route generation using curvature and lane-center adjustments is applied, the vehicle may control various operations based on the enhanced route. For example, the vehicle may adjust braking or acceleration to follow the curvature-smoothed route, modify steering commands to maintain alignment with the lane-center-adjusted trajectory, or update sensor-scanning parameters to focus on upcoming high-curvature regions. Additional operational controls may include autonomous-driving control, sensor control, braking timing, acceleration-rate control, alarm-timing control, or forward-collision-warning timing based on the enhanced driving route. One or more auxiliary devices (e.g., engine brake, exhaust brake, hydraulic retarder, electric retarder, regenerative brake, etc.) may be controlled based on the feature of enhanced driving-route generation using curvature and lane-center adjustments. For example, the control of braking force may be dynamically adjusted to match the curvature of the route, while steering-based adjustments may influence the operation of retarder systems to enhance stability during turns or lane changes. One or more communication devices (e.g., a modem, network adapter, radio transceiver, antenna, etc.) may be controlled based on the feature of enhanced driving-route generation using curvature and lane-center adjustments. For example, communication protocols such as V2X or LTE may adjust to provide real-time updates or alerts regarding route curvature or lane position, ensuring enhanced communication during dynamic driving conditions. Minimum risk maneuver (MRM) operation(s) may also be controlled based on the feature of enhanced driving-route generation using curvature and lane-center adjustments. For example, an MRM procedure may use the enhanced route to guide the vehicle toward a lane-centered, curvature-smoothed path when transitioning to a minimal-risk state. A minimal risk maneuver (e.g., a minimal risk maneuver, a minimum risk maneuver) may minimize a risk of collision by directing the vehicle to a lowered-risk position when a driver does not respond to an intervention request, and one or more processors may control vehicle movement along the enhanced route for a set period during the MRM. Biased driving operation(s) may also be controlled based on the feature of enhanced driving-route generation using curvature and lane-center adjustments. For example, the driving control apparatus may use the enhanced route to maintain a biased lateral position within the lane rather than driving exactly at the lane center. The apparatus may determine a biased target lateral distance (e.g., an intentionally adjusted offset from the lane center or another reference point) to improve stability or safety under varying driving conditions. During maneuvers such as lane changes, the apparatus may adjust the biased lateral distance based on curvature-smoothed and lane-center-adjusted route information to maintain a safer gap from adjacent vehicles or obstacles.

One or more sensors (e.g., IMU sensors, camera, LIDAR, RADAR, blind-spot monitoring sensor, lane-departure warning sensor, parking sensor, light sensor, rain sensor, traction-control sensor, tire-pressure sensor, seatbelt sensor, airbag sensor, etc.) may also be controlled based on the feature of enhanced driving-route generation using curvature and lane-center adjustments. For example, sensor-scanning ranges or update rates may be adapted to focus on upcoming curvature-smoothed sections or areas near the lane-center-adjusted trajectory. Such sensor control may support various autonomous-driving operations, including steering control, braking control, stability control, lane-keeping assistance, collision-avoidance functions, or adaptive-headlight control based on the enhanced driving route. An autonomous driving level and/or autonomous-driving activation or deactivation may also be controlled based on the feature of enhanced driving-route generation using curvature and lane-center adjustments. For example, when the enhanced route indicates increased curvature or lane-center deviation risk, the driving control apparatus may adjust the autonomous-driving level or modify required user attentiveness, such as requiring the driver to place hands on the steering wheel or look ahead more frequently. The apparatus may also restrict certain video content on a vehicle display or deactivate autonomous driving when the enhanced route conditions exceed the operational limits of the selected autonomous-driving level. In the various flowcharts of this document, at least some of the steps may be omitted or their mutual order may be changed, and at least some of the various examples of this document may be performed at a specific point in time of the flowchart steps. The operations of the various flowcharts in this document may be performed by at least one of a control device 100, a processor 130, and an autonomous vehicle 10. In addition, redundant contents in the drawings of this document may be omitted. In this document, ‘control device 100’ may also be referred to as ‘autonomous vehicle control device 100’.

The ‘driver control assistance system’ mentioned in this document refers to hardware and software that may help the driver continuously control the longitudinal and lateral movements of the vehicle. This driver control assistance system may be referred to as an ‘autonomous driving system’ or ‘system’ in this document.

The ‘Feature’ mentioned in this document may refer to a specific system function that aids the driver in a defined traffic scenario, situation, and system boundary.

The ‘Dynamic Control’ mentioned in this document may refer to performing the operational and tactical functions necessary to move the vehicle in real time. This may include control of the vehicle's lateral and longitudinal movements, monitoring of the road environment, responding to events in the road traffic environment, operational planning, and signaling.

The ‘System Boundaries’ mentioned in this document may refer to verifiable or measurable limits or conditions set by the manufacturer, within or up to the conditions that affect the system or the function of the system designed to provide assistance to the driver and the ability of the system to operate as intended.

Each step of the flowcharts mentioned in this document may be described as being performed by the processor 130 of the autonomous vehicle 10, but is not limited thereto, and the control device 100 or the autonomous vehicle 10 itself may perform the example of each step.

According to the present disclosure, a vehicle may generate a smoother and more comfortable autonomous-driving route by gradually adjusting points along the road so that sharp curves are reduced, and the vehicle stays centered within its lane. The vehicle may repeatedly examine a series of route points ahead, calculate how each point should shift to reduce sudden curvature, calculate how each point should shift to better match the lane center, and then update the point only when both adjustments call for movement in the same direction. By repeating this process until the adjustments become smaller than a threshold value, the vehicle may create a final route that is smoother, easier to control, and more stable for passengers, while remaining properly aligned within the lane.

Hereinafter, examples will be described in detail with reference to the accompanying drawings, but the same or corresponding constituent elements will be given the same reference numerals regardless of the drawing numbers, and redundant descriptions thereof will be omitted.

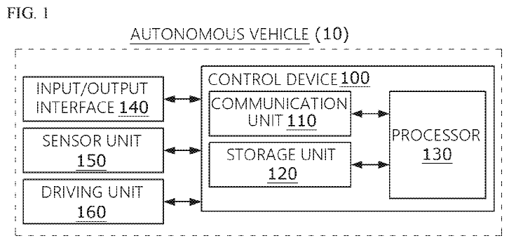

FIG. 1 shows an example of an autonomous vehicle 10.

The autonomous vehicle 10 may include a control device 100, a communication unit 110, a storage unit 120, a processor 130, an input/output interface 140, a sensor unit 150, and a driving unit 160. Each of these components in FIG. 1 may be implemented inside the vehicle.

The autonomous vehicle 10 may be dynamically controlled in various driving situations through an autonomous driving system. For example, the autonomous driving system may provide both driving stability and convenience through longitudinal control (acceleration and deceleration) and lateral control (lane keeping and changing) of the autonomous vehicle 10. This autonomous driving system may monitor the driving environment through sensors and control devices, and process data in real time to adjust the vehicle's position, driving speed, direction, and various driving responses (e.g., lane centering, hazard avoidance, or curve handling, etc.).

According to an example of the present disclosure, the autonomous vehicle 10 may regenerate a route based on numerical optimization to improve control trackability and ride comfort in a curved section with curvature. At this time, the control device 100 may calculate a first correction value for smoothing the curvature and a second correction value for moving the route point to a lane center for each route point of the driving route, and selectively correct the route point by comparing the directions of the two correction values (e.g., both values indicating inward movement, both indicating outward movement, or both indicating no change, etc.).

The control device 100 may be formed integrally with the internal components of the vehicle, and may be implemented as a separate and independent device from other components inside the autonomous vehicle 10 to communicate with the internal components of the vehicle through various connection means (e.g., CAN bus, wireless network, wired connection, or an optical network, etc.). The control device 100 may include a communication unit 110, a storage unit 120, and a processor 130 to manage the longitudinal and lateral control of the vehicle, and may additionally include other components such as an input/output interface 140, a sensor unit 150, and a driving unit 160 to perform complex control functions according to the driving situation (e.g., overtaking, merging, or navigating tight curves, etc.).

The control device 100 may store data collected from the sensor unit 150 during driving in the storage unit 120 and process it in real time to control the safety and convenience functions of the vehicle. For example, the control device may perform overall control and management of the autonomous driving system, such as providing a notification in a situation where driver intervention is required based on data detected from the sensor unit 150 (e.g., sudden deceleration of a leading vehicle, poor lane visibility, or driver inattentiveness, etc.).

The control device 100 may display the vehicle control status or receive driver input to control driving functions through a user interface linked with an HMI (Human-Machine Interface) based on various driver settings and driving conditions (e.g., preferred lane-keeping strength, customizable follow distance, or autonomous-mode sensitivity, etc.).

The communication unit 110 may perform communication with other control devices inside the vehicle to share data between systems or transmit and receive various information through connection with the outside of the vehicle. The communication unit 110 may transmit control signals and data between internal components using various in-vehicle communication methods such as CAN communication and Ethernet, and may link driving information and external data in real time through communication with a user terminal, other vehicles (V2V: Vehicle-to-Vehicle), infrastructure (V2I: Vehicle-to-Infrastructure), or an external server (e.g., cloud-based routing updates, cooperative lane-change requests, or remote diagnostics, etc.).

The communication unit 110 may perform short-range communication, GNSS (Global Navigation Satellite System) module (e.g., GPS module), V2X (Vehicle-to-Everything) communication, optical communication, broadcast transmission/reception, and ITS (Intelligent Transport Systems) communication functions. For example, the communication unit 110 may support stable data transmission at close range using various wireless communication technologies such as Bluetooth, RFID (Radio Frequency Identification), IrDA (Infrared Data Association), UWB (Ultra-Wideband), ZigBee, NFC (Near Field Communication), Wi-Fi, Wi-Fi Direct, and Wireless USB (e.g., for device pairing, short-range sensing, or authentication exchange, etc.). In addition, it may perform long-distance communication through a mobile communication module and a wireless internet module based on mobile communication networks such as LTE and 5G to improve the performance of the autonomous driving system by receiving real-time data or linking with the cloud (e.g., live traffic information, high-definition map updates, or over-the-air software upgrades, etc.).

The storage unit 120 may include various types of memory that may store data and may be integrated into the control device 100 or the processor 130 or configured as a separate module. The storage unit 120 may include non-volatile memory (e.g., hard disk drive, flash memory) and volatile memory, and may combine them to implement a memory system with various capacities and performances (e.g., high-speed cache for sensor fusion, larger-capacity modules for map storage, or low-latency buffers for control loops, etc.).

According to one example, the storage unit 120 may include a memory that may store and manage various data related to the autonomous driving system (e.g., historical route traces, driver preference profiles, or long-term diagnostic logs, etc.).

According to an example of the present disclosure, the storage unit 120 may store information necessary for performing a curvature-based optimization algorithm, such as numerical route point information, correction values, and iterative calculation results (e.g., convergence thresholds, accumulated adjustment magnitudes, or per-iteration objective values, etc.).

According to an example of the present disclosure, the storage unit 120 may provide a memory including at least one instruction, and the instructions may be executed by the processor 130 and used to perform control functions such as route optimization calculation, correction value calculation, and convergence determination (e.g., detecting oscillating corrections, identifying stable convergence, or triggering route regeneration, etc.). The storage unit 120 may store various data related to the autonomous driving route optimization algorithm, such as map information, route points, correction history, number of repetitions, and convergence status, along with these instructions. The subject of the operations performed in the following drawings may be the processor 130, the autonomous vehicle control device 100, the autonomous vehicle 10, or the instructions.

The processor 130 may communicate with various internal components of the autonomous vehicle 10, including the communication unit 110, the storage unit 120, the input/output interface 140, the sensor unit 150, and the driving unit 160, through electrical or operational connections, and may control the operation of each component and perform data processing (e.g., filtering sensor noise, combining multi-sensor inputs, or validating lane geometry, etc.). The processor 130 is a central processing unit for executing commands and calculating data, and may collect, process, and analyze data in real time according to the driving environment of the vehicle to perform vehicle control.

The processor 130 may be implemented in the form of hardware, software, or a combination thereof, and may perform vehicle control logic in the form of, for example, a microcontroller, FPGA, or ASIC (e.g., ARM-based MCU, GPU-accelerated planner, or dedicated perception coprocessor, etc.). In addition, it may include a multi-processor configuration for controlling complex autonomous driving and driver assistance systems (e.g., distributed processors for perception, prediction, and control layers, etc.). This processor configuration may support comprehensive control and stable performance of the vehicle through the execution of autonomous driving and assistance systems, sensor data processing, communication data management, and driving-related judgment functions.

According to an example of the present disclosure, the processor 130 may calculate a first correction value for smoothing a curvature based on a route point on an existing route, calculate a second correction value for moving the route point to a lane center, compare the directions of the two correction values to selectively apply the corrected point, and repeatedly perform this to generate a converged optimal route (e.g., until lateral deviation falls below a threshold, until curvature changes stabilize, or until a preset iteration count is reached, etc.).

The input/output interface 140 receives input related to vehicle control from the user and plays a role in delivering vehicle control status and system operation information to the user.

The input/output interface 140 may perform the function of receiving various inputs from the user and delivering the vehicle control status to the user. For example, the input/output interface 140 may include at least one of input through physical buttons provided inside the autonomous vehicle 10, input through soft buttons displayed on the display of the autonomous vehicle 10, user's voice input, and user's gesture input (e.g., swipe gestures, wake-word activation, or steering-wheel button presses, etc.).

The input means may include physical buttons, soft keys on a touch display, a voice recognition function, a gesture recognition function, etc., through which the user may input commands such as an autonomous driving system activation request, function switching, or driving assistance setting (e.g., selecting adaptive cruise mode, adjusting speed limits, or toggling lane-change assistance, etc.).

In addition, the input means may receive user input through an input device provided on the steering wheel of the autonomous vehicle 10. For example, through buttons mounted on the steering wheel, the driver may input a command to activate or deactivate the autonomous driving system while driving. Such steering wheel-based input may support the user to quickly control the autonomous driving function by providing an intuitive interface (e.g., one-touch mode switching, quick lane-change requests, or canceling autonomous control, etc.).

The output means may include a display, an audio module (e.g., speaker), a haptic module, etc., and may provide the user with the status of the autonomous driving system, a control takeover request notification, function activation status, etc., in visual, auditory, and tactile forms (e.g., warning tones, steering-wheel vibrations, or dynamic route indicators, etc.).

In addition, the status of the autonomous driving system may be intuitively checked through a head-up display (HUD), a cluster, an AVN (Audio Video Navigation), and a display embedded in a rear-view mirror or side mirrors. In addition, the status of the autonomous driving system may be checked through the display of a console installed in each row of the autonomous vehicle 10, an application of a user terminal, and the like (e.g., smartphone notifications, rear-seat displays, or voice-based summaries, etc.).

According to an example of the present disclosure, the finally generated optimal route may be output through the input/output interface 140 (e.g., displayed as a smoothed trajectory, highlighted with lane-center alignment, or shown with projected curvature values, etc.).

The sensor unit 150 may include a number of sensors that support the stable operation of the autonomous driving system by detecting various driving and environmental information in real time. The sensor unit 150 may measure the distance and speed to surrounding objects through long-range detection sensors such as RADAR (Radio Detection and Ranging) and LIDAR (Light Detection and Ranging), and may include an ultrasonic sensor to detect objects near the autonomous vehicle 10 (e.g., curbs, parking pillars, or low-speed pedestrians, etc.).

In addition, the sensor unit 150 may include a position sensor such as GPS to collect the position information of the autonomous vehicle 10, and an optical sensor to provide ambient illuminance information so that the system may respond to changes in light (e.g., entering tunnels, driving at dusk, or encountering sudden glare, etc.). In addition, the sensor unit 150 may include an accelerator pedal and a brake pedal sensor, a steering wheel detection sensor, a seating sensor, etc., to monitor the driving control status of the autonomous vehicle 10 and user actions (e.g., pedal misapplication, sudden steering input, or seat occupancy detection, etc.).

The sensor unit 150 may include a camera. The camera may be classified into an external camera and an internal camera. The external camera recognizes the road and the surrounding environment, and the internal camera may comprehensively grasp the situation inside and outside the vehicle by detecting the driver's state (e.g., eye gaze tracking, distraction detection, drowsiness detection, etc.) or the indoor situation.

The sensor unit 150 may include a heart rate sensor, a pressure sensor, an infrared sensor, etc., to collect the driver's biometric information or various environmental data (e.g., cabin temperature, occupant load, or abnormal movement, etc.).

The driving unit 160 provides the driving force necessary for the driving of the autonomous vehicle 10 and may include various components that control the operation of the vehicle according to the command output from the control device 100. The driving unit 160 may be composed of devices that generate and transmit the power of the vehicle, such as an engine, a motor, a transmission, and a wheel drive system, and a controller that controls them, and through these components, acceleration, deceleration, and direction change of the autonomous vehicle 10 may be performed (e.g., smooth lane entry, controlled cornering, or adaptive acceleration during merging, etc.).

The driving unit 160 may be controlled to maintain driving safety by performing longitudinal control (acceleration and deceleration) and lateral control (lane keeping and changing) of the vehicle. For example, it receives a command from the control device 100 to adjust the output of the motor or adjust the rotation speed and direction of the wheels so that the vehicle may follow the driving route (e.g., stabilizing curvature transitions, compensating for crosswinds, or adjusting for road slope, etc.).

In addition, the driving unit 160 may include a brake system to reduce the speed of the vehicle or stop it during driving. The driving unit 160 may control the autonomous vehicle 10 through control via an electric motor in the case of an electric vehicle and based on engine output in the case of an internal combustion engine vehicle (e.g., torque vectoring, regenerative braking, or downshift-based deceleration, etc.).

According to an example of the present disclosure, the driving unit 160 may receive optimized route data from the control device 100 and control longitudinal and lateral movements to precisely follow the route (e.g., fine steering adjustments, predictive deceleration before curves, or smooth lateral drift toward the center of the lane, etc.).

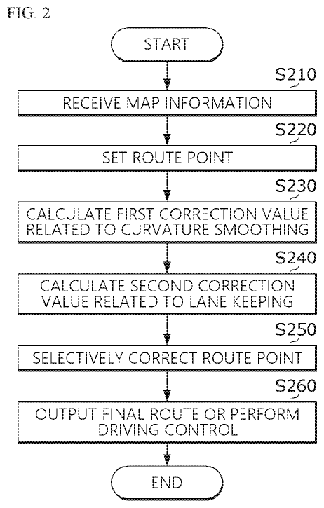

FIG. 2 shows an example of generation of a curved section autonomous driving route.

An autonomous vehicle control device 100 may receive map information from a map data provision server or an in-vehicle storage (S210).

The map information may include digital map data that serves as a reference for recognizing a driving environment of an autonomous vehicle and generating a driving route. Such map information may be, for example, precision map information. The control device 100 may extract existing route data including lane boundary information and lane centerline information from the received map information (e.g., left/right lane markings, centerline vectors, or lane-edge polylines, etc.).

The received map information may generally be absolute coordinate-based data including factors such as a road curvature, the number of lanes, a lane width, a lane type, lane boundary coordinates, and additional metadata (e.g., speed limits, road grades, or roadway connection nodes, etc.). The control device 100 may store the received map information in an in-vehicle memory and reference the map information during a subsequent route optimization process.

The control device 100 may secure basic data for setting route points on the existing route, including the received lane information. Here, the lane information may include a coordinate array representing left and right lane boundaries with respect to a driving lane of an autonomous vehicle (e.g., GPS-referenced polylines, spline-based lane models, or lidar-extracted boundaries, etc.).

The control device 100 may form a forward route with respect to a current position of the autonomous vehicle based on the received coordinate data (e.g., projecting 20-50 m ahead, selecting a drivable corridor, or filtering segments with poor confidence, etc.).

In addition, the map information may be data acquired from a GPS-based precision position correction system, a lidar-based mapping result, or an external high-precision map provision platform. The control device 100 may preprocess the map information in an internal processor 102 and use the preprocessed map information as an input value for a route optimization algorithm (e.g., coordinate normalization, noise reduction, or interpolation of missing segments, etc.).

Next, the control device 100 of the autonomous vehicle may set one or more route points within a predetermined distance forward from the current position of the autonomous vehicle based on the existing route extracted from the map information (S220).

The control device 100 may set the route points to include a plurality of positions spaced a predetermined distance from the existing route data stored in a memory. For example, the control device 100 may set a total of 25 route points at 1-meter intervals with respect to a route that is 25 meters ahead of the current position of the vehicle (e.g., 10-40 points depending on speed, curvature, or prediction horizon, etc.).

Each set route point may be two-dimensional position information including coordinate values (x, y), and this information may be used as a unit processing target for curvature correction and lane keeping correction (e.g., curvature smoothing, lateral alignment, or predictive trajectory shaping, etc.).

The control device 100 may independently perform correction calculation for each route point in a subsequent operation (e.g., evaluating curvature change, computing lateral deviation, or determining movement feasibility, etc.).

The control device 100 may sequentially sort the set route points in consideration of the driving direction of the autonomous vehicle and set a first point as the closest to the current position. However, the present disclosure is not limited thereto, and the control device 100 may set a point at any position as the first point (e.g., a mid-segment point, a lane-center reference point, or a point chosen for numerical stability, etc.).

Such point sorting may be performed to ensure that curvature smoothing and lane keeping correction are performed in the driving order (e.g., from near-field to far-field, from lowest index to highest index, or from most critical segment to least critical segment, etc.).

In addition, the control device 100 may assign internally identifiable point indices to the set route points and store the set route points so that each point may be referenced in a subsequent operation when calculating and applying correction values (e.g., index 0 for closest point, index 24 for farthest point, or any structured indexing scheme, etc.).

The control device 100 for an autonomous vehicle may calculate a first correction value for smoothing the curvature of the corresponding point for each set route point (S230).

The first correction value may be a numerical reference value for reducing the curvature of the entire route by adjusting the position of the corresponding route point (e.g., shifting the point inward on a curve, reducing sharp bends, or smoothing oscillatory segments, etc.).

Specifically, the control device 100 may calculate amounts of curvature changes based on a plurality of reference positions spaced a predetermined distance to the left and right of a specific route point (e.g., ±0.02 m offsets, ±0.05 m offsets, or dynamically chosen lateral offsets at a longitudinal position of the specific route point on a driving lane, etc.).

For example, the control device 100 may calculate a curvature for a position moved 0.02 m to the left and a position moved 0.02 m to the right from the reference point (e.g., using numerical differentiation, spline fitting, or discrete curvature estimation, etc.).

Here, the curvature may be estimated through the sum of squares of curvature values calculated using the corresponding point and adjacent preceding and succeeding points (e.g., three-point curvature method, multi-point smoothing, or polynomial-based curvature estimation, etc.).

The control device 100 may calculate the first correction value, which is a numerical value corresponding to a rate of curvature change, based on a difference in the squares of the curvatures at the two distances (±0.02 m). For example, the first correction value may be calculated using the following numerical equation.

$$Gradient {N}_{Curv} = \frac{{Curv ( i , + dh )}^{2} - Curv {( i , - dh )}^{2}}{2 * dh}$$

Curv(i,+dh) denotes a curvature value at a position shifted dh to the right from a reference point i, and Curv(i, dh) denotes a curvature value at a position shifted dh to the left from the same point. dh denotes a small distance, and in actual implementations, may be set to a small value, such as 0.02 m (e.g., 0.01 m for high-precision maps, 0.03 m for coarse maps, or any selectable micro-offset, etc.).

The control device 100 may repeatedly perform this numerical optimization calculation for each route point to evaluate the possibility of moving the route point to minimize the curvature of the entire route. Accordingly, the first correction value may be secured as a basic control parameter that may be used in a correction direction to be determined in a subsequent operation (e.g., determining leftward adjustment, rightward adjustment, or zero adjustment, etc.).

The control device 100 for an autonomous vehicle may calculate a second correction value for each set route point to enable the corresponding point to better follow a lane center (S240).

The control device 100 may calculate a center position between left lane boundary coordinates and right lane boundary coordinates corresponding to each route point. The center position may be calculated as an average of the coordinate values of the left lane boundary and the right lane boundary (e.g., midpoint of lateral boundaries, geometric center of lane edges, or interpolated lane-center estimate, etc.).

The control device 100 may calculate a distance difference between the calculated center position and the current position of the corresponding route point and calculate a second correction value to minimize the difference (e.g., lateral deviation, drift from lane center, or accumulated offset, etc.).

The second correction value is a numerical value that includes the direction and magnitude for moving the route point toward the center position and may serve as a reference value for adjusting the corresponding point to more accurately follow the lane center (e.g., shifting the point leftward, shifting the point rightward, or maintaining position if centered, etc.). The second correction value may be used as a determination reference for preventing lane departure and stably maintaining lane keeping driving (e.g., in narrow lanes, curved segments, or high-speed sections, etc.).

Next, the control device 100 for an autonomous vehicle may selectively correct the corresponding route point based on the first and second correction values calculated for each route point (S250).

The control device 100 may determine whether to correct the route point based on the first correction value for curvature smoothing and the second correction value for lane keeping.

In this case, the control device 100 may determine the corresponding route point as a correction target only when the first and second correction values act in the same direction (e.g., both positive, both negative, or both indicating no lateral movement, etc.).

Specifically, the control device 100 may determine that the same sign between the first and second correction values indicates that the two correction directions do not intersect, and the route point is intended to move in the same direction. In this case, the control device 100 may calculate a final correction value by adding the two correction values and then apply the corresponding correction value to the route point to move its position (e.g., combined left shift, combined right shift, or small incremental adjustment, etc.).

On the other hand, when the first and second correction values act in opposite directions, the control device 100 may not correct the corresponding route point. Such a conditional correction method may serve as a determination logic of the device to prevent unnecessary or excessive route distortion when the two optimization objectives of curvature smoothing and lane smoothing conflict with each other (e.g., sudden curve flattening versus lane-centering pull, etc.).

The control device 100 may repeatedly perform such conditional determination and correction application for each route point, and this process may be an operation of generating an intermediate result for the generation of the final route through repeated calculation on the entire list of route points (e.g., updating all points sequentially, updating points in batches, or iterating until stability, etc.).

Next, the control device 100 for an autonomous vehicle may generate a final driving route based on the corrected route points and output the corresponding route or control the driving of the autonomous vehicle (S260).

The control device 100 may repeatedly perform correction calculation that considers curvature smoothing and lane keeping for each route point and then determine whether the entire route has converged. When the amount of change in the correction value is less than or equal to a preset reference value compared to the previous repetition, the control device 100 may determine that the route correction has converged and determine the corresponding route as the final route (e.g., when change <1%, when adjustments oscillate minimally, or when deviation stabilizes, etc.).

Such convergence determination may be performed, for example, based on the sum of the correction values (or cost function value) of all route points calculated in each repetition loop.

Specifically, when a difference in the cost function between the current repetition and the previous repetition is less than or equal to a set reference value (e.g., 1%), the control device 100 may terminate the repetition calculation and consider the current route as the optimal route. When an upper limit on the number of repetitions is set, the control device 100 may select a route with the lowest cost and terminate its calculation regardless of the presence of convergence even when the maximum number of repetitions has been reached in a state in which the reference value is not met (e.g., to reduce computation time, to avoid instability, or to ensure real-time responsiveness, etc.).

When the final route is determined, the control device 100 may output the corresponding route to the driver via the input/output interface 140 of the autonomous vehicle.

For example, the control device 100 may display the optimized driving route to the driver via a visual output device, such as a display device, a cluster, or a head-up display (HUD) (e.g., highlighted lanes, smoothed trajectory overlay, or predicted curvature indicators, etc.).

The output route information may include key information of the route, such as scheduled driving routes, scheduled lane change points, sections of high curvature, or predicted control difficulty regions (e.g., tight turns, merge zones, or heavy-traffic areas, etc.).

The input/output interface 140 may intuitively provide such route information to the driver in the form of visual icons, colors, warning messages, or dynamic animations, etc.

In addition, voice guidance or haptic feedback is provided as needed to enable the driver to easily recognize the driving plan of the system and prepare for manual control takeover or driver intervention (e.g., steering-wheel vibration, spoken alerts, or dashboard highlighting, etc.).

In addition, the control device 100 may generate a reference signal for real-time control of steering, speed, acceleration, and the like of the vehicle based on the output route. At this time, the generated control signal may be transmitted to an in-vehicle driving control unit and used to perform actual autonomous driving (e.g., torque control, brake modulation, or fine steering adjustments, etc.).

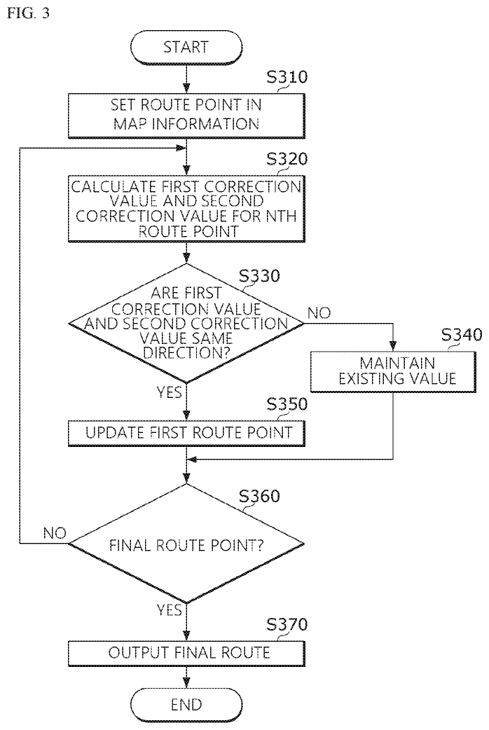

FIG. 3 shows an example of generating of the curved section autonomous driving route in detail.

The control device 100 for an autonomous vehicle may extract lane boundaries and existing route information from precise map information, and based on this, set route points within the forward section from the current position of the autonomous vehicle (S310). The corresponding operation may be performed in the same manner as that described in FIG. 2 (e.g., extracting lane edges, centerlines, or drivable corridor shapes, etc.).

The control device 100 may set a plurality of route points spaced a predetermined distance (e.g., 1 m) from each other with respect to the current position of the vehicle and use each of the points as a unit processing target for subsequent correction calculations (e.g., curvature smoothing, lane-center alignment, or predictive path shaping, etc.).

The control device 100 may calculate the first correction value for curvature smoothing and the second correction value for lane keeping for an N^{th} route point currently being processed (S320).

This operation may follow the calculation process described in detail in FIG. 2. That is, the control device 100 may calculate the first correction value based on the amounts of curvature changes at reference positions spaced to the left and right of the reference route point and simultaneously calculate the second correction value based on the center position of the left and right lane boundaries corresponding to the corresponding point (e.g., midpoint estimation, weighted lane-center interpolation, or filtered lane-center computation, etc.).

The calculated correction value may be used as a reference value for determining whether to correct the route point in a subsequent operation (S330) (e.g., determining shift direction, movement magnitude, or non-movement conditions, etc.).

The control device 100 for an autonomous vehicle may determine whether the directions of the first and second correction values calculated for the N^{th} route point are the same (S330).

The first correction value indicates a correction direction for curvature smoothing, and the second correction value indicates a correction direction for lane keeping. When the directions of the two correction values are the same, the control device 100 may determine that the route point is a correction target.

On the other hand, when the directions of the two correction values are opposite, the control device 100 may determine not to perform correction. That is, the control device 100 may be configured to correct the route point only when the first and second correction values act in the same direction (e.g., both pulling toward the lane center, both pulling outward, or both indicating a small stabilizing shift, etc.).

In actual implementation, since the correction values are represented as numerical values, when the signs of the two values are the same, the two correction values are considered to be in the same direction, and when the signs are different, the two correction values are considered to be in opposite directions. For example, when the first correction value is positive and the second correction value is also positive, the two values may be interpreted as an intent to move the route point in the same direction (e.g., to the right or toward the outer lane boundary, etc.).

Based on the determination result, the control device 100 may proceed to a subsequent operation (S340 or S350).

When the first and second correction values act in opposite directions, the control device 100 may maintain the existing value without correcting the position of the current N^{th} route point (S340).

That is, when the first and second correction values do not act in the same direction, the control device 100 may bypass the correction process so that the route point is not corrected. When the two correction values are in conflicting directions, indiscriminate application of the correction values may degrade driving stability or route quality (e.g., causing zig-zag shapes, overshooting lane center, or destabilizing curvature flow, etc.). Accordingly, under the corresponding conditions, the position data of the existing route points may be maintained without correction.

When it is determined that the existing value is maintained, the control device 100 may proceed to the next operation S360 (final route point determination) and continuously process the next point.

When the first and second correction values calculated for the N^{th} route point act in the same direction, the control device 100 for an autonomous vehicle may update the corresponding route point (S350).

When it is determined that the two correction values act in the same direction, the control device 100 may calculate a single final correction value by adding the two correction values. For example, when the first correction value is +0.015 and the second correction value is +0.005, the sum of the two values, +0.02, may be set as the final correction value (e.g., representing a small lateral shift toward the desired alignment, etc.).

The control device 100 may reflect the final correction value in the existing position coordinates of the corresponding route point to calculate new position coordinates. For example, when original route point coordinates are (x, y) and the final correction value requires a +0.02 m shift in a y-axis direction, new coordinates may be updated to (x, y+0.02) (e.g., to reduce lane deviation, smooth curvature, or stabilize upcoming vehicle motion, etc.).

In this way, the control device 100 may correct a single route point, thereby improving route quality and driving performance. Thereafter, the corrected point may be reflected in a list of routes, and the process may proceed to the next operation that is final point determination (S360).

The control device 100 for an autonomous vehicle may determine whether the route point currently being processed is a final point among all route points (S360).

The control device 100 may determine a time point to terminate repetitive processing by comparing a preset total number of route points with a currently processed point index N (e.g., checking index boundaries, verification counters, or loop-completion conditions, etc.).

For example, when the entire route consists of 25 points and the point index currently being processed corresponds to a 25^{th} point, the corresponding point may be considered the final point.

When the current point is not the final point, the control device 100 may proceed back to the previous operation S320 (correction value calculation operation) for repetitive processing and continuously process the next point. Conversely, when the current point is the final point, the control device 100 may proceed to a subsequent operation S370 to output the entire route correction result.

Such conditional branching may serve as a core control logic for a repetition-based route optimization loop (e.g., per-point iteration, convergence-by-segment, or full-route update cycle, etc.).

When the correction processing for all route points is completed, the control device 100 for an autonomous vehicle may output the final driving route including the corrected route points (S370).

The control device 100 may collect the correction results for each route point, constitute the collected correction results in a continuous route data structure, and transmit the final route to the input/output interface 140 or driving unit 160 of the vehicle (e.g., as a smoothed trajectory, optimized centerline, or curvature-stabilized driving path, etc.).

The final output route may be used as a reference route for the actual driving of the autonomous vehicle and used to guide a physical driving operation in conjunction with steering, speed, and acceleration control of the vehicle.

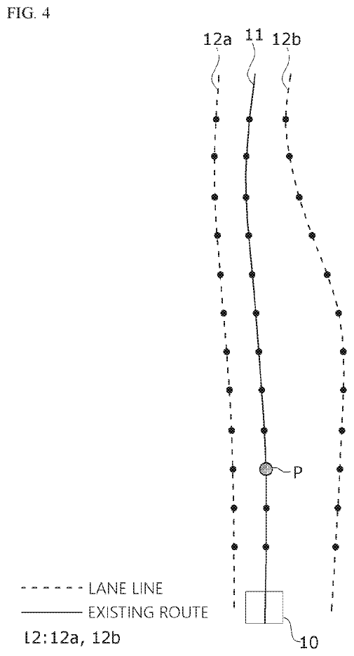

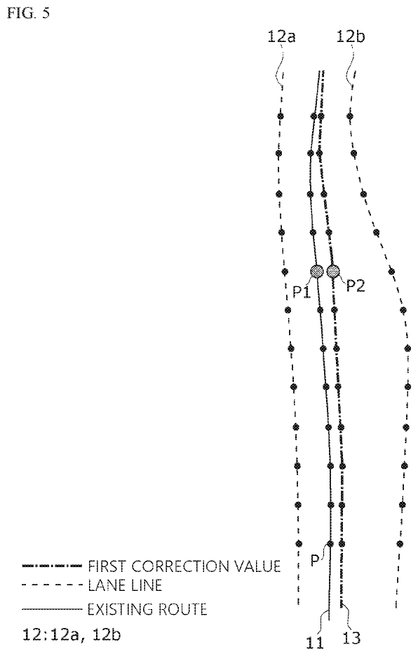

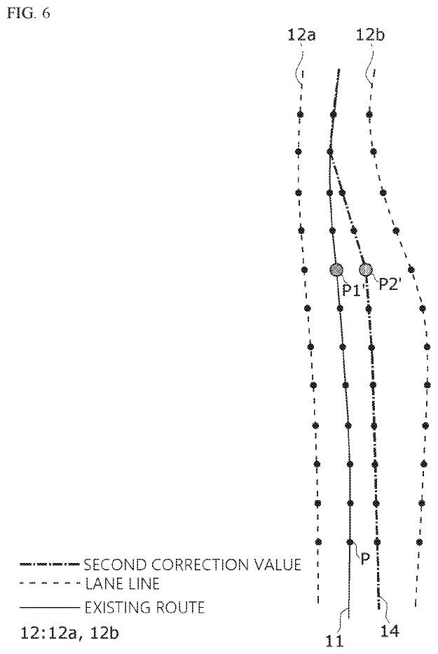

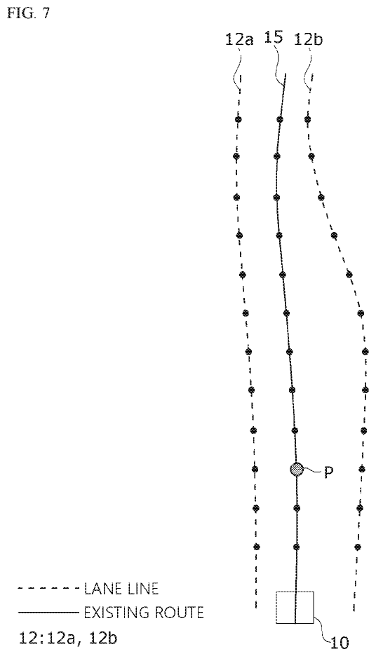

FIGS. 4 to 7 show examples of generation of the curved section autonomous driving route.

FIG. 4 shows an example of a process of setting, by the control device for an autonomous vehicle, route points of the existing route based on precise map information. The control device 100 for an autonomous vehicle may set a plurality of route points P at regular intervals (e.g., 1 m) with respect to the current position of the autonomous vehicle 10 (e.g., forming evenly spaced points, projecting points along a lane centerline, or generating points based on map-derived geometry, etc.).

As illustrated in FIG. 4, the driving lane of the vehicle includes a left lane boundary 12a and a right lane boundary 12b, and a lane line 11 of a host vehicle currently set by the autonomous driving system may be set on a lane. The plurality of route points may be a unit processing target of numerical optimization calculation for curvature correction and lane keeping (e.g., curvature smoothing, lateral alignment toward the lane center, or transition shaping between segments, etc.).

Specifically, each set route point may be a numerical optimization calculation target for curvature smoothing or lane keeping in a subsequent operation, and independent correction calculations may be performed by assigning a unique index to each route point. As illustrated in FIG. 4, route points continuously distributed across a predetermined section (e.g., 25 m) ahead of the vehicle may be formed, and these points may be automatically generated based on the existing route on the precision map (e.g., using spline interpolation, polyline segmentation, or map-based point sampling, etc.).

The control device 100 may use each route point as basic information for calculating the first correction value based on curvature change and the second correction value based on the lane center (e.g., computing curvature deviation, calculating lateral offsets, or assessing lane-center drift, etc.).

FIG. 5 is a view exemplarily illustrating a process of calculating the first correction value for curvature smoothing of a route point P1 of the existing route and generating a new route point P2 corrected based on the first correction value by the control device for an autonomous vehicle.

The control device 100 for an autonomous vehicle may set the plurality of route points P along the existing route 11 set based on the current position of the autonomous vehicle 10 and calculate the first correction value by calculating the amount of curvature change for each route point.

The control device 100 may calculate a curvature at each of positions spaced a small distance (e.g., ±0.02 m) from each other to the left and right of the specific route point P1 and numerically derive a curvature change rate based on a difference in squared curvature values (e.g., curvature(i+dh)²−curvature(i−dh)², or similar finite-difference approximations, etc.). In this case, the calculated first correction value may include the moving direction and magnitude for smoothing the curvature of the corresponding point, and based on this correction value, a position of P1 may be updated to a new position P2. A corrected route 13 illustrated in the drawing may be a route formed by applying the first correction value to the route points P of the existing route 11 (e.g., producing a smoother trajectory, reducing local curvature spikes, or eliminating abrupt bends, etc.).

FIG. 6 shows an example of a process of calculating the second correction value for lane keeping of a route point P1′ of the existing route and generating a new route point P2′ corrected based on the second correction value by the control device for an autonomous vehicle. The control device 100 for an autonomous vehicle may reference the coordinates of the left lane boundary 12a and the right lane boundary 12b corresponding to each route point P of the existing route 11, which is set based on the current position of the autonomous vehicle 10 (e.g., map-derived boundaries, sensor-fused lane edges, or filtered lane-boundary models, etc.).

The control device 100 may calculate a distance difference between the route point P1′ and the center position with respect to a center position 14 between the two lane boundaries and move the corresponding point to minimize such a distance difference to generate the corrected point P2′ (e.g., shifting left, shifting right, or keeping the point unchanged if already centered, etc.). The second correction value may include the direction and magnitude for the position shift and contribute to adjusting the driving route so that the vehicle may more stably follow the lane centerline (e.g., improving lateral comfort, reducing weaving, or compensating for lane shifts, etc.).

The lane centerline 14 illustrated in FIG. 6 may be formed at an average position of the left lane boundary 12a and the right lane boundary 12b and may serve as a reference line to guide the autonomous vehicle to precisely maintain the lane keeping. The calculated second correction value may be compared with the first correction value based on curvature smoothing to determine whether the route point is finally corrected (e.g., ensuring both curvature and centering objectives align, etc.).

FIG. 7 shows an example of a driving route 15 finally generated as a result of the control unit for an autonomous vehicle performing the correction calculation based on the first correction value for curvature smoothing and the second correction value for lane keeping. The control device 100 for an autonomous vehicle may calculate the first and second correction values for each of the plurality of route points P set along the existing route 11 based on the precision map with respect to the current position of the autonomous vehicle 10 (e.g., using iterative optimization, sequential point updating, or batch processing, etc.).

Each correction value may reflect different optimization objectives, such as curvature smoothing and keeping of the lane centerlines (with respect to the lane boundaries 12a and 12b), and the control device 100 may correct the corresponding point by adding the two correction values only when the directions of the two correction values are the same and perform the conditional correction method of generating an optimal route by omitting correction when the directions of the two correction values are opposite (e.g., preventing overcorrection, preserving lane geometry, or maintaining route stability, etc.).

The final route 15 illustrated in FIG. 7 is the result of repeatedly applying such a conditional correction process to all route points and may be generated in a shape that is curvature-smoothed and closer to the lane center (e.g., improving passenger comfort, reducing steering workload, or enhancing lane-tracking precision, etc.).

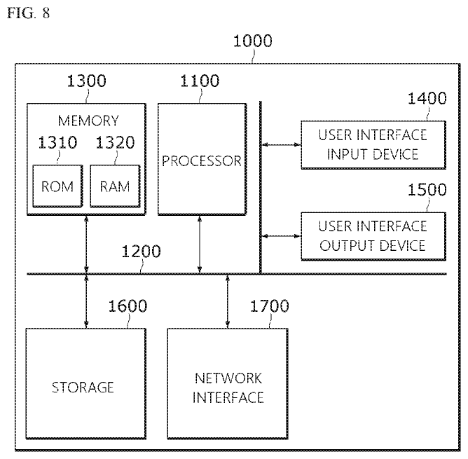

FIG. 8 shows an example computing system (e.g., a computing device of a vehicle or any other apparatus). One or more controllers, processors, etc. described herein, such as one or more components of the vehicle 10, and any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A control device for an autonomous vehicle according to an example of the present disclosure may comprise: a memory configured to store at least one instruction; and one or more processors connected to the memory, wherein, when the instructions are executed by the one or more processors, the control device may be configured to: set one or more route points on an existing route including lane information; calculate a first correction value for smoothing a curvature of the route points; calculate a second correction value for moving the route points to a lane center; and selectively correct the route points based on the first and second correction values and generate a driving route including one or more corrected route points.

In the control device for an autonomous vehicle according to some examples, the instructions may be configured to output the generated driving route through an input/output interface of an autonomous vehicle, or control driving of the autonomous vehicle along the generated driving route.

In the control device for an autonomous vehicle according to some examples, the one or more route points may be set to be spaced a predetermined distance from each other on the existing route.

In the control device for an autonomous vehicle according to some examples, the instructions may be configured to calculate the first correction value based on amounts of curvature changes at a plurality of reference positions spaced from each other to the left and right of the route point.

In the control device for an autonomous vehicle according to some examples, the instructions may be configured to calculate the second correction value based on a center position between a left lane boundary and a right lane boundary corresponding to the route point.

In the control device for an autonomous vehicle according to some examples, the instructions may be configured to calculate the second correction value to minimize a distance difference between the route point and the center position.

In the control device for an autonomous vehicle according to some examples, the instructions may be configured to correct the route point only when the first correction value and the second correction value act in the same direction.

In the control device for an autonomous vehicle according to some examples, when the first correction value and the second correction value act in the same direction, the instructions may be configured to correct a position of the route point by adding the two correction values.

In the control device for an autonomous vehicle according to some examples, when the first correction value and the second correction value do not act in the same direction, the instructions may be configured not to correct the route point.

In the control device for an autonomous vehicle according to some examples, when an amount of change in a correction value is less than or equal to a preset reference value compared to previous repetition after the correction of the route points is repeatedly performed, the instructions may be configured to determine that the driving route is a final route.

A method of controlling an autonomous vehicle according to an example of the present disclosure may comprise: setting one or more route points on an existing route including lane information; calculating a first correction value for smoothing a curvature of the route points; calculating a second correction value for moving the route points to a lane center; selectively correcting the route point based on the first correction value and the second correction value; and generating a driving route including the one or more corrected route points.

In the method of controlling an autonomous vehicle according to some examples, the method may comprise outputting the generated driving route through an input/output interface of an autonomous vehicle or controlling driving of the autonomous vehicle along the generated driving route.

In the method of controlling an autonomous vehicle according to some examples, the one or more route points may be set to be spaced a predetermined distance from each other on the existing route.

In the method of controlling an autonomous vehicle according to some examples, the first correction value may be calculated based on amounts of curvature changes at a plurality of reference positions spaced from each other to the left and right of the route point.

In the method of controlling an autonomous vehicle according to some examples, the second correction value may be calculated based on a center position between a left lane boundary and a right lane boundary corresponding to the route point.

In the method of controlling an autonomous vehicle according to some examples, the second correction value may be calculated to minimize a distance difference between the route point and the center position.

The method of controlling an autonomous vehicle according to some examples may comprise correcting the route point only when the first correction value and the second correction value act in the same direction.

The method of controlling an autonomous vehicle according to some examples may comprise, when the first correction value and the second correction value act in the same direction, correcting a position of the route point by adding the two correction values.

The method of controlling an autonomous vehicle according to some examples may comprise not correcting the route point when the first correction value and the second correction value do not act in the same direction.

The method of controlling an autonomous vehicle according to some examples may comprise determining that the driving route is a final route when an amount of change in a correction value is less than or equal to a preset reference value compared to previous repetition after the correction of the route points is repeatedly performed.

According to examples of the present disclosure, by applying an optimization algorithm that considers curvature smoothing and lane keeping, it is possible to reduce control errors of a vehicle and improve ride comfort.

Effects of the present disclosure are not limited to the above effects, and other effects that are not described will be able to be clearly understood by those skilled in the art based on the following description.

While the present disclosure has been described with reference to examples, it will be understood by those skilled in the art that various modifications and changes may be made thereto without departing from the spirit and scope of the disclosure as set forth in the claims that follow.

What is claimed is:

1. An apparatus of a vehicle, the apparatus comprising:
a processor; and
a memory storing at least one instruction that, when executed by the processor, is configured to cause the apparatus to:
set, based on lane boundary information of a driving lane of the vehicle, a plurality of route points on an existing driving route of the vehicle,
determine a first adjustment value for reducing amounts of curvature changes of the plurality of route points,
determine a second adjustment value for moving the plurality of route points toward a lane center of the driving lane of the vehicle,
adjust, based on the first adjustment value and the second adjustment value, the plurality of route points,
generate an updated driving route comprising the adjusted plurality of route points,
output a signal indicating the updated driving route, and
control, based on the signal, an operation of the vehicle.

2. The apparatus of claim 1, wherein the at least one instruction, when executed by the processor, is configured to cause the apparatus to:
output the updated driving route through an interface of the vehicle, and
control autonomous driving of the vehicle along the updated driving route.

3. The apparatus of claim 1, wherein the plurality of route points are set to be spaced a predetermined distance apart from each other on the existing driving route.

4. The apparatus of claim 1, wherein the at least one instruction, when executed by the processor, is configured to cause the apparatus to determine the first adjustment value based on amounts of curvature changes at a plurality of reference positions, and wherein the plurality of reference positions comprise positions located to a left side of the driving lane and positions located to a right side of the driving lane.

5. The apparatus of claim 1, wherein the at least one instruction, when executed by the processor, is configured to cause the apparatus to determine the second adjustment value based on a center position between a left lane boundary of the driving lane and a right lane boundary of the driving lane.

6. The apparatus of claim 5, wherein the at least one instruction, when executed by the processor, is configured to cause the apparatus to determine the second adjustment value to minimize a distance difference between each of the plurality of route points and the center position.

7. The apparatus of claim 1, wherein the at least one instruction, when executed by the processor, is configured to cause the apparatus to adjust the plurality of route points based on the first adjustment value and the second adjustment value indicating a same direction of movement.

8. The apparatus of claim 1, wherein the at least one instruction, when executed by the processor, is configured to cause the apparatus to adjust a position of a route point of the plurality of route points based on:
the first adjustment value and the second adjustment value indicating a same direction of movement, and
a sum of the first adjustment value and the second adjustment value.

9. The apparatus of claim 1, wherein the at least one instruction, when executed by the processor, is configured to cause the apparatus to iteratively adjust the plurality of route points until an amount of change in the iterative adjustment satisfies a threshold condition.

10. The apparatus of claim 1, wherein the at least one instruction, when executed by the processor, is configured to cause the apparatus to determine that the updated driving route is a final route based on an amount of change in an adjustment value between successive adjustments less than a preset reference value.

11. A method performed by an apparatus of a vehicle, the method comprising:
setting, based on lane boundary information of a driving lane of the vehicle, a plurality of route points on an existing driving route of the vehicle;
determining a first adjustment value for reducing amounts of curvature changes of the plurality of route points;
determining a second adjustment value for moving the plurality of route points toward a lane center of the driving lane of the vehicle;
adjusting, based on the first adjustment value and the second adjustment value, the plurality of route points;
generating an updated driving route comprising the adjusted plurality of route points;
outputting a signal indicating the updated driving route; and
control, based on the signal, an operation of the vehicle.

12. The method of claim 11, further comprising:
outputting the driving route through an interface of the vehicle; and
controlling autonomous driving of the vehicle along the updated driving route.

13. The method of claim 11, wherein the plurality of route points are set to be spaced a predetermined distance apart from each other on the existing driving route.

14. The method of claim 11, wherein the determining of the first adjustment value comprises determining the first adjustment value based on amounts of curvature changes at a plurality of reference positions, and wherein the plurality of reference positions comprise positions located to a left side of the driving lane and positions located to a right side of the driving lane.

15. The method of claim 11, wherein the determining of the second adjustment value comprises determining the second adjustment value based on a center position between a left lane boundary of the driving lane and a right lane boundary of the driving lane.

16. The method of claim 15, wherein the determining of the second adjustment value comprises determining the second adjustment value to minimize a distance difference between each of the plurality of route points and the center position.

17. The method of claim 11, further comprising:
adjusting the plurality of route points based on the first adjustment value and the second adjustment value indicating a same direction of movement.

18. A vehicle comprising:
a sensor configured to obtain lane boundary information of a driving lane of the vehicle; and
a processor circuit configured to cause the vehicle to:
set, based on the lane boundary information, a plurality of route points on an existing driving route of the vehicle,
determine, for each route point of the plurality of route points, a first adjustment value based on curvature changes at reference positions on a left side of the driving lane and a right side of the driving lane,
determine, for each route point of the plurality of route points, a second adjustment value based on a center position between a left lane boundary of the driving lane and a right lane boundary of the driving lane,
based on the first adjustment value and the second adjustment value indicating a same direction of movement, adjust a position of at least one route point of the plurality of route points,
generate an updated driving route, wherein the updated driving route comprises the adjusted positions of the plurality of route points,
output a signal indicating the updated driving route, and
control, based on the signal, autonomous driving of the vehicle.

19. The vehicle of claim 18, wherein the processor circuit is configured to cause the vehicle to set the plurality of route points to be spaced a predetermined distance apart from each other on the existing driving route.

20. The vehicle of claim 18, wherein the processor circuit is configured to cause the vehicle to iteratively adjust the plurality of route points until an amount of change in the iterative adjustment satisfies a threshold condition.
